(19) United States
(12) Patent Application Publication
(10) Pub. No.: US 2017/0197320 A1
(43) Pub. Date: Jul. 13, 2017

(54) CUTTER

(71) Applicant: Hsiu-Man Yu Chen, Taichung (TW)

(72) Inventor: Hsiu-Man Yu Chen, Taichung (TW)

(21) Appl. No.: 14/991,767

(22) Filed: Jan. 8, 2016

(51) Int. Cl. B26B 3/08; B26B 11/00

(52) U.S. Cl. CPC B26B 3/08; B26B 11/006

(57) ABSTRACT

A cutter includes a main body. One end of the main body is provided with a cutting head. The cutting head wraps a cutting unit. Two sides of the cutting unit extend out of the second openings. The main body includes two protection members disposed at the two sides of the cutting unit. The two protection members are disposed apart from the main body. The cutting unit extends out of the cutting head, and the protection members used to wrap the two sides of the cutting unit are disposed apart from the main body for the cutter to be operated smoothly so as to enhance the efficiency of removing packaging members.

### BACKGROUND OF THE INVENTION

1. Field of the Invention

The present invention relates to a cutter, and more particularly to a cutter able to cut off and remove various kinds of packaging members.

2. Description of the Prior Art

In order to prevent articles from being collided and damaged during transportation, the articles are usually boxed or bagged with adhesive tape or staples. After the articles are packed in a box, and even the box itself is tied up by plastic packaging straps for insuring the articles to be kept intact in the box. A conventional cutter, as shown in FIG. 1, is often employed to unseal a packing box. The cutter 1 comprises a main body 2. The top edge of the main body 2 has a holding portion 3. Two lugs 4 extend from two sides of the main body 2. A gap 5 is formed between each lug 4 and the main body 2. The main body 2 wraps a cutting unit 6. One end of the cutting unit 6 is formed with a pointed portion 7. Another end of the cutting unit 6 is formed with a knife-edge portion 8. The pointed portion 7 extends out of the holding portion 3. The knife-edge portion 8 extends out of the gaps 5. The pointed portion 7 can be used to pierce the packing members and the knife-edge portion 8 can be used to cut the packing members, such that the cutter is able to cut off and remove various kinds of packaging members. Although the cutter is able to cut off and remove various kinds of packaging members, the cutter cannot be operated smoothly. The main body 2 wraps the cutting unit 6. Only the pointed portion 7 and the knife-edge portion 8 of the cutting unit 6 are exposed out of the main body 2. When the cutter 1 pierces the packing member, it is not easy and smooth for the user to pull up the cutter 1 because the main body 2 itself has a certain thickness. Accordingly, the inventor of the present invention has devoted himself based on his many years of practical experiences to solve these problems.

### SUMMARY OF THE INVENTION

The primary object of the present invention is to provide a cutter which is able to cut off and remove various kinds of packaging members. The cutter can be operated smoothly so as to enhance the efficiency of removing packaging members.

In order to achieve the aforesaid object, the cutter of the present invention comprises a main body, a cutting unit, and two protection members. The main body is a plate body. Two ends of a long axis of the main body are defined as a first end and a second send, respectively. The first end of the main body is provided with a cutting head. The cutting head is substantially in a triangle shape. The cutting head is formed with a top edge and two first flat surfaces. The cutting head is provided with an accommodation space. A central portion of the top edge of the cutting head is provided with a first opening. The first opening is in communication with the accommodation space. The main body is provided with second openings at the two first surfaces. The second openings are in communication with the accommodation space, respectively. The cutting unit has a platy shape. The cutting unit is inserted in the accommodation space of the cutting head. The cutting unit has a first pointed end portion. The first pointed end portion extends out of the first opening. Two sides of the cutting unit extend out of the second openings. The cutting unit has a knife-edge portion. The two protection members are adapted to wrap the two sides of the cutting unit, respectively. The two protection members are disposed apart from the main body. One side of each protection member, facing the cutting unit, has a second flat surface. The first flat surface is parallel to the second flat surface. A first angle is defined between the second flat surface and the long axis of the main body. Each protection member has a third flat surface extending outward from a lower end the second flat surface towards the second end of the main body. A second angle is defined between the third flat surface and the long axis of the main body. The second angle is greater than the first angle. A first reduced opening is formed between the third flat surface and the main body.

The two sides of the cutting unit of the cutter of the present invention extends out of the second openings, and the protection members used to wrap the two sides of the cutting unit are disposed apart from the main body for the cutter to be operated smoothly so as to enhance the efficiency of removing packaging members.

### BRIEF DESCRIPTION OF THE DRAWINGS

FIG. 1 is a perspective view of a conventional cutter;

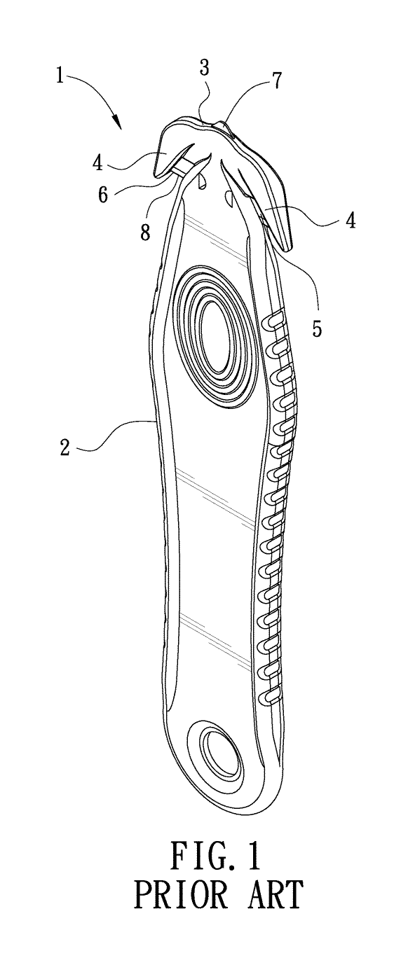

FIG. 2 is a perspective view of the present invention;

FIG. 3 is a front view of the present invention;

FIG. 4 is a partial sectional view of the present invention;

FIG. 5 is a first schematic view of the present invention when in use, illustrating that the cutter is used to unseal a packing box;

FIG. 6 is a second schematic view of the present invention when in use, illustrating that the cutter is used to unseal a packing box;

FIG. 7 is a schematic view of the present invention, illustrating that the cutter is used to pull out staples; and

FIG. 8 is a front view of another embodiment of the present invention.

### DETAILED DESCRIPTION OF THE PREFERRED EMBODIMENTS

Embodiments of the present invention will now be described, by way of example only, with reference to the accompanying drawings.

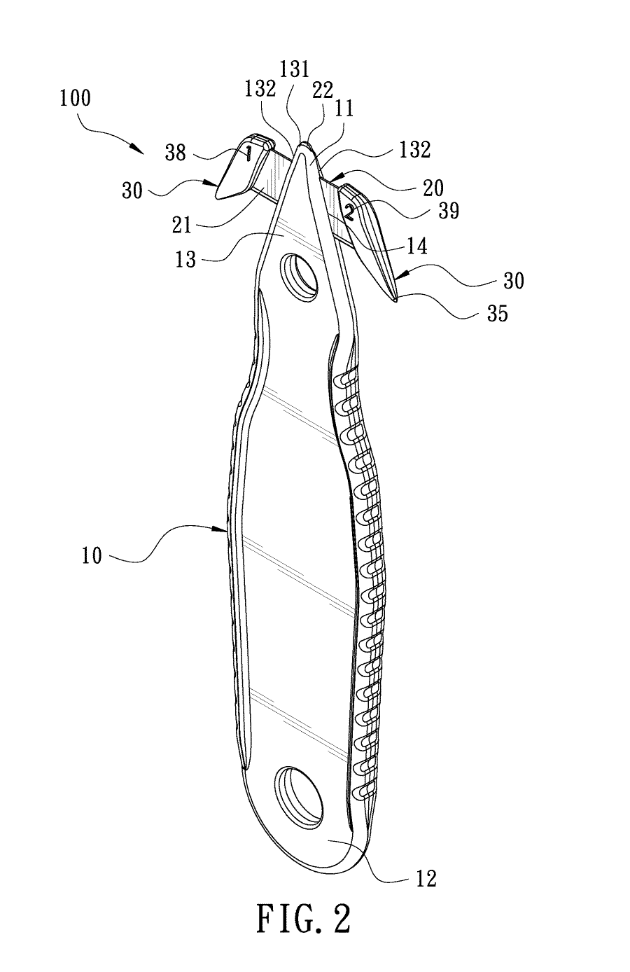

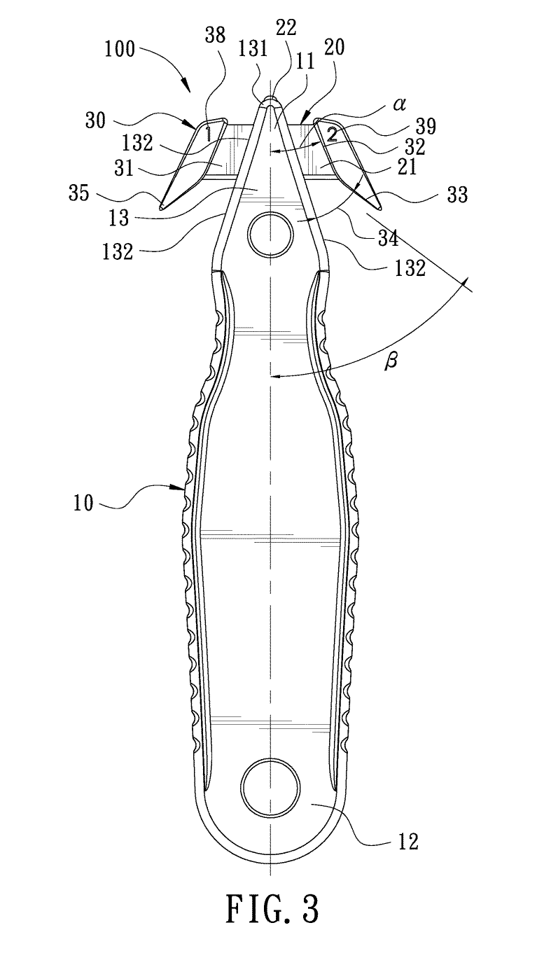

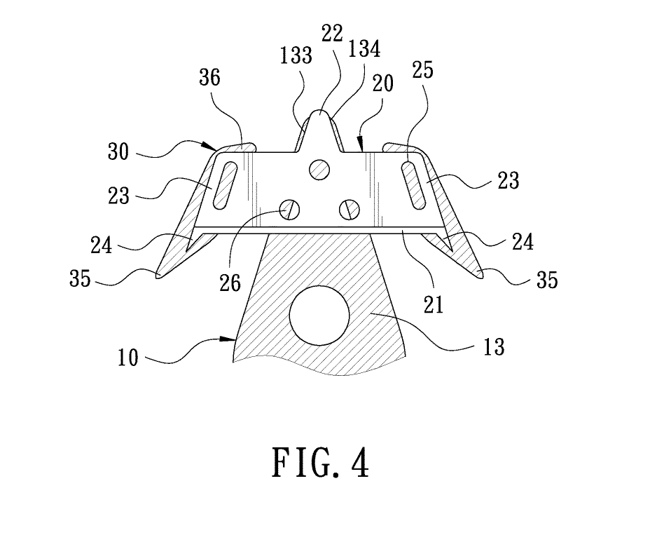

FIG. 2 is a perspective view of the present invention. FIG. 3 is a front view of the present invention. FIG. 4 is a partial sectional view of the present invention. The present invention discloses a cutter 100. The cutter 100 comprises a main body 10, a cutting unit 20, and two protection members 30.

The main body 10 is a plate body. Two ends of a long axis of the main body 10 are defined as a first end 11 and a second send 12, respectively. The first end 11 of the main body 10 is provided with a cutting head 13. The cutting head 13 is substantially in a triangle shape. The cutting head 13 is formed with a top edge 131 and two first flat surfaces 132. The cutting head 13 is provided with an accommodation space 133. A central portion of the top edge 131 of the cutting head 13 is provided with a first opening 134. The first opening 134 is in communication with the accommodation space 133. The main body 10 is provided with second openings 14 at the two first surfaces 132. The second openings 14 are in communication with the accommodation space 133, respectively.

The cutting unit 20 has a platy shape. The cutting unit 20 is inserted in the accommodation space 133 of the cutting head 13. Two sides of the cutting unit 20 extend out of the second openings 14. Furthermore, the cutting unit 20 has a knife-edge portion 21. In this embodiment of the present invention, the cutting unit 20 is generally in a trapezoid shape. The cutting unit 20 has a first pointed end portion 21. The first pointed end portion 21 extends out of the first opening 134. The two sides of the cutting unit 20 have inclined ends 23, respectively. The inclined ends 23 extend out of the second openings 14, respectively. The cutting unit 20 is integrally formed with the knife-edge portion 21 opposite the first pointed end portion 22. Two ends of the knife-edge portion 21 protrude outward to form second pointed end portions 24, respectively. In addition, the cutting unit 20 is formed with a pair of elongate holes 25 close to the inclined ends 23. A central portion of the cutting unit 20 is provided with a plurality of penetrating holes 26.

The two protection members 30 are adapted to wrap the two sides of the cutting unit 20, respectively. The two protection members 30 are disposed apart from the main body 10, such that a passage 31 is formed between each of the protection members 30 and the main body 10. One side of each protection member 20, facing the cutting unit 20, has a second flat surface 32. The first flat surface 132 is parallel to the second flat surface 32. A first angle α is defined between the second flat surface 32 and the long axis of the main body 10. Each protection member 30 has a third flat surface 33 extending outward from a lower end the second flat surface 32 towards the second end 12. A second angle β is defined between the third flat surface 33 and the long axis of the main body 10. The second angle β is greater than the first angle α. A first reduced opening 34 is formed between the third flat surface 33 and the main body 10. An acute angle is defined between an outer side of each protection member 30 and the third flat surface 33, such that each protection member 30 is formed with a pointed corner 35. A top edge of each protection member 30 is formed with a holding portion 36. In this embodiment of the present invention, the second angle β minus the first angle α is in the range of 20-40 degrees.

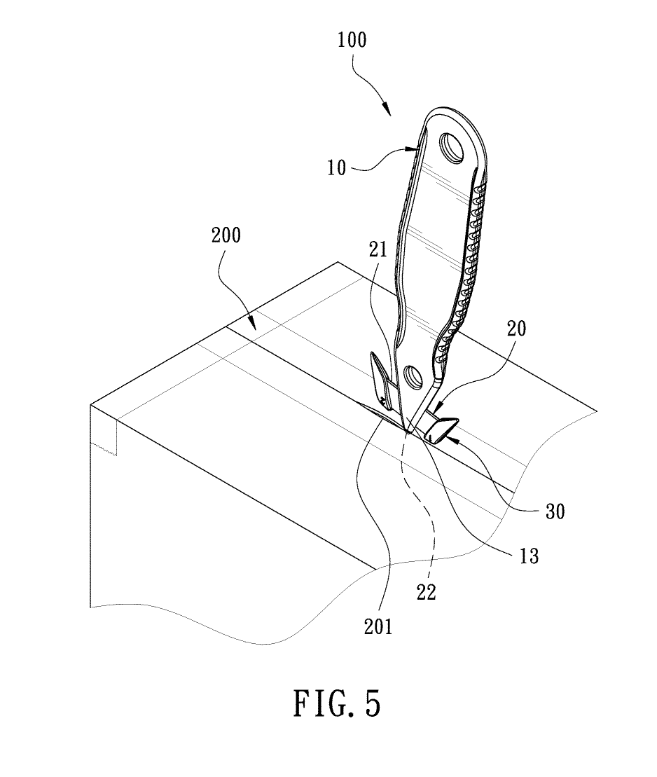

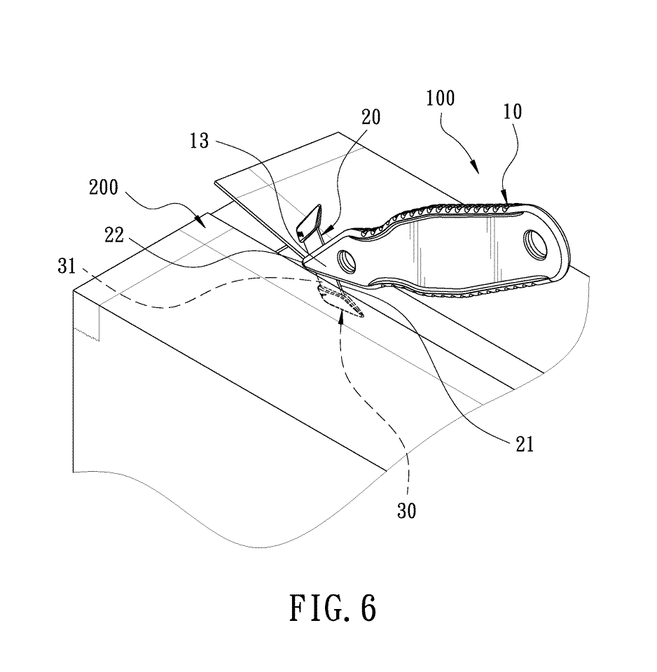

FIG. 5 and FIG. 6 are first and second schematic views of the present invention when in use, in cooperation with FIG. 2 and FIG. 3, packaging members, such as adhesive tape 200 and a plurality of staples 300, are generally used to seal a packing box. When the user wants to cut the adhesive tape 200 which is seamless and has their edges closely attached to the packing box, the first pointed end portion 22 of the cutting unit 20 is used to pierce the adhesive tape 200 to form a crack 201. Afterward the cutting head 13 in inserted into the crack 201 and the position of the cutter 100 is adjusted for the knife-edge portion 21 to align with the adhesive tape 200, enabling one of the passages 31 to be located in the crack 201. The adhesive tape 200 is cut by the knife-edge portion 21. Thus, the cutter 100 of the present invention can cut and remove the packaging members easily.

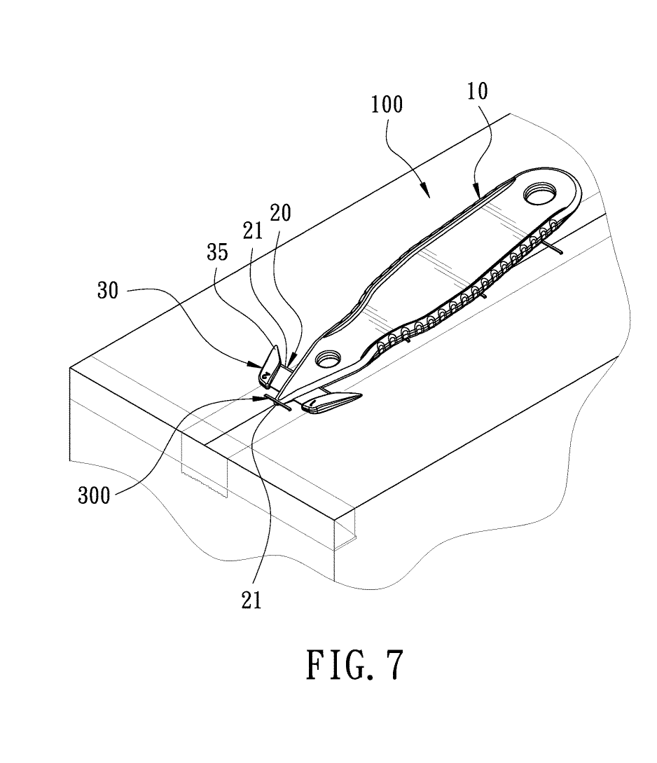

FIG. 7 is a schematic view of the present invention, illustrating that the cutter is used to pull out staples. The first pointed end portion 22 of the cutter 100 can be used to pull up and remove the staples 300 from the packing box. In addition, the pointed corner 35 of each protection member 30 of the cutter 100 can be used to pull up the staples 300. Thereby, the cutter 100 can remove the staples in different ways, enhancing the efficiency of removing the packaging members from the packing box.

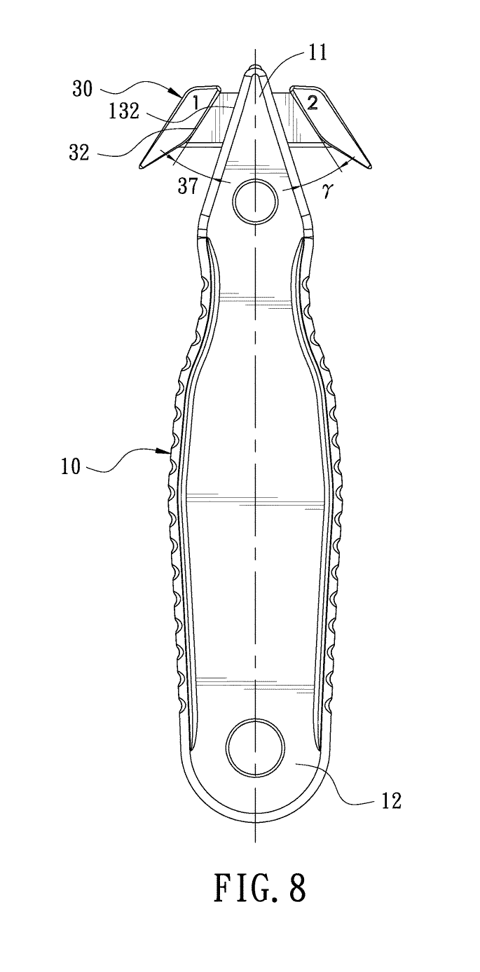

FIG. 8 is a front view of another embodiment of the present invention. A third angle γ is defined between the first flat surface 132 of the main body 10 and the second flat surface 32 of each protection member 30, such that a second reduced opening 37 is formed between the main body 10 and the second flat surface 32. The third angle γ is in the range of 1-10 degrees. Through the first reduced opening 34 in cooperation with the second reduced opening 37, the cutter 100 can compress the packing members in a two-stage manner for a smooth cutting.

Each of the protection members 30 of the present invention is formed with the pointed corner 35 through the first angle α, the second angle β, and the acute angle. The pointed corner 35 can be used to pierce the packing member, such as a carton, adhesive tape, packing tape, and the like. After that, the cutter 100 is pulled with the knife-edge portion 21 to lean against the inner side of the packing member to carry out cutting work easily.

It is noted that the second pointed end portions 24 of the cutting unit 20 are wrapped by the protection members 30. The second pointed end portions 24 can enhance the structural strength of the protection members 30.

It is noted that the protection members 30 are integrally formed with the main body 10 through the elongate holes 25 and the penetrating holes 26 by injection.

It is noted that the protection members 30 are provided with a first marked portion 38 and a second marked portion 39, respectively. The user can selectively use the knife-edge portion 21 close to the first marked portion 38 first. When the knife-edge portion 21 close to the first marked portion 38 is blunt or damaged, the knife-edge portion 21 close to the second marked portion 39 can be used to cut the packing members.

It is noted that the holding portion 36 can be used to hold against the surface of an article, enabling the first pointed end portion 22 to have a working width able to penetrate the article so as to limit the penetration and cutting depth of the first pointed end portion 22.

Thereby, the cutting unit 20 is used to pierce and cut the adhesive tape 200, and the pointed corners 35 and the first pointed end portion 22 are used to pull up the staples 300. The cutter of the present invention is able to cut off and remove various kinds of packaging members. The cutting unit 20 extends out of the second openings 14, and the protection members 30 used to wrap the two sides of the cutting unit 20 are disposed apart from the main body 10 for the cutter 100 to be operated smoothly so as to enhance the efficiency of removing packaging members.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cutter, comprising:
a main body, two ends of a long axis of the main body being defined as a first end and a second send respectively, the first end of the main body being provided with a cutting head, the cutting head being substantially in a triangle shape, the cutting head being formed with a top edge and two first flat surfaces, the cutting head being provided with an accommodation space, a central portion of the top edge of the cutting head being provided with a first opening, the first opening being in communication with the accommodation space, the main body being provided with second openings at the two first surfaces, the second openings being in communication with the accommodation space respectively;
a cutting unit, the cutting unit being inserted in the accommodation space of the cutting head, the cutting unit having a first pointed end portion, the first pointed end portion extending out of the first opening, two sides of the cutting unit extending out of the second openings, the cutting unit having a knife-edge portion; and
two protection members, the two protection members being adapted to wrap the two sides of the cutting unit respectively, the two protection members being disposed apart from the main body, one side of each protection member, facing the cutting unit, having a second flat surface, the first flat surfaces each being parallel to of the second flat surfaces, a first angle being defined between the second flat surface and the long axis of the main body, each protection member having a third flat surface extending outward from a lower end the second flat surface towards the second end of the main body, a second angle being defined between the third flat surface and the long axis of the main body, the second angle being greater than the first angle, a first reduced opening being formed between the third flat surface and the main body;

2. The cutter as claimed in claim 1, wherein a top edge of each protection member is formed with a holding portion.

3. The cutter as claimed in claim 1, wherein the cutting unit is substantially in a trapezoid shape, the two sides of the cutting unit have inclined ends respectively, the inclined ends extend out of the second openings respectively, and the cutting unit is integrally formed with the knife-edge portion opposite the first pointed end portion.

4. The cutter as claimed in claim 1, wherein two ends of the knife-edge portion protrude outward to form second pointed end portions, respectively.

5. The cutter as claimed in claim 3, wherein the cutting unit is formed with a pair of elongate holes close to the inclined ends, a central portion of the cutting unit is provided with a plurality of penetrating holes, and the protection members are integrally formed with the main body through the elongate holes and the penetrating holes by injection.

6. The cutter as claimed in claim 1, wherein a passage is formed between each of the protection members and the main body.

7. The cutter as claimed in claim 1, wherein an acute angle is defined between an outer side of each protection member and the third flat surface, such that each protection member is formed with a pointed corner.

8. The cutter as claimed in claim 1, wherein a third angle is defined between each first flat surface of the main body and the second flat surface of each protection member, such that a second reduced opening is formed between the main body and the second flat surface of each protection member.

9. The cutter as claimed in claim 8, wherein the third angle is in the range of 1-10 degrees.

10. The cutter as claimed in claim 1, wherein the second angle minus the first angle is in the range of 20-40 degrees.
